(19) United States
(12) Patent Application Publication
(10) Pub. No.: US 2010/0213643 A1
(43) Pub. Date: Aug. 26, 2010

(54) RAPID SYNTHESIS OF POLYCRYSTALLINE SILICON SHEETS FOR PHOTO-VOLTAIC SOLAR CELL MANUFACTURING

(76) Inventors: Prasad N. Gadgil, Santa Clara, CA (US); Rajat Roychoudhury, San Jose, CA (US); Mushtaq Mulla, Kingston (CA); Indrajit Banerjee, San Jose, CA (US)

Correspondence Address: WILSON, SONSINI, GOODRICH & ROSATI, 650 PAGE MILL ROAD, PALO ALTO, CA, 94304-1050, US

(21) Appl. No.: 12/713,003

(22) Filed: Feb. 25, 2010

Related U.S. Application Data
(60) Provisional application No. 61/155,894, filed on Feb. 26, 2009.

(51) Int. Cl. C01B 33/025; B01J 19/00; B01J 19/08; B28B 1/14

(52) U.S. Cl. 264/489; 423/350; 422/129; 204/157.43; 204/157.42; 422/127; 422/186; 264/491

(57) ABSTRACT

A simple and direct methodology for synthesis of polycrystalline silicon sheets is demonstrated in our invention, where silica (SiO₂) and elemental carbon (C) are reacted under RF or MW excitation. These polycrystalline silicon sheets can be directly used as feedstock/substrates for low cost photovoltaic solar cell fabrication. Other techniques, such as textured polycrystalline silicon substrate formation, in situ doping, and in situ formation of p-n junctions, are described, which make use of processing equipments and scheme setups of various embodiments of the invention.

### CROSS-REFERENCE

This application claims the benefit of U.S. Provisional Patent Application No. 61/155894, filed Feb. 26, 2009, which application is incorporated herein by reference.

### BACKGROUND OF THE INVENTION

Current processes for directly producing silicon wafers and sheets are cumbersome and expensive. These processes involve breakdown of silane (SiH₄) at high temperatures (420° C.), and reduction of dichlorosilane (SiCl₂H₂) and silicon tetrachloride (SiCl₄). Reactions below provide a visualization of traditional steps:

SiH₄→Si+2H₂

SiCl₂H₂+H₂→Si+2HCl

SiCl₄+2H₂→Si+4HCl

It is also imperative to point out that silane gas is pyrophoric, explosive, and difficult to handle and contain. Reduction of dichlorosilane, and silicon tetrachloride, also require high temperature reactions, and the deposition rates are slow (20-50 μm per hour). Indirect silicon production starting from conversion of silica to silane, dichlorosilane, and silicon tetrachloride is also known to be expensive.

In addition, direct synthesis of silicon from silica (SiO₂) and carbon (C) is a known process in an arc furnace. However, molten silicon needs to be converted into an ingot and then sliced into wafers or sheets. This can be expensive because of the numerous additional secondary manufacturing steps involved. Thus, traditional silicon wafer production techniques include safety and cost concerns. See, e.g., U.S. Patent Publication No. 2009/0074647, US Patent Publication No. 2009/0028773, U.S. Patent Publication No. 2007/0217988 and U.S. Pat. No. 7,381,392, which are herein incorporated by reference in their entirety.

Thus, a need exists for improved systems and methods for producing silicon wafers. A further need exists for producing such wafers in a safe and cost-effective manner.

### SUMMARY OF THE INVENTION

The invention provides systems and methods for forming silicon sheets in a variety of shapes. Various aspects of the invention described herein may be applied to any of the particular applications set forth below or for any other types of manufacture of silicon products, such as substrates for solar cells. The invention may be applied as a standalone system or method, or as part of an integrated system, such as solar cell production. It shall be understood that different aspects of the invention can be appreciated individually, collectively, or in combination with each other.

This invention relates to rapid and direct synthesis of silicon sheets, such as polycrystalline silicon sheets. The traditional synthesis processes used to date involve silicon ingots to be manufactured and sliced into wafers or sheets. The invention utilizing a rapid and direct synthesis method of producing silicon sheets (or other textured poly-crystalline silicon substrates) will, for example, be used as feedstock for fabrication of low-cost photovoltaic solar cells.

An aspect of the invention provides a process apparatus for the formation of a silicon substrate. The process apparatus may include a trough for receiving a starting material comprising silica and carbon. The trough may be placed within a reaction chamber (also “system chamber” herein). The reaction chamber may be enclosed and insulated to contain the heat. An excitation source may provide excitation power to the starting material for a given duration, thereby causing the starting material to react and melt, to form a silicon sheet. The excitation source may be a radiofrequency (RF) excitation source, or a microwave (MW) excitation source. The silicon material may be cooled and annealed. The silicon sheet may be removed from the trough.

In some embodiments, the trough may include topography features that may be used to provide texture to the silicon sheet that is formed. For example, the trough may include pyramidal features that may cause complementary surfaces features to be formed in the silicon sheet.

A method for forming a silicon substrate may be provided in accordance with another embodiment of the invention. A starting material may be provided comprising silica and elemental carbon. The starting material may be placed in a trough within a reaction chamber, and may receive an excitation energy. The excitation energy may cause the starting material to form a resulting material comprising silicon, and to melt to conform to the shape of the trough. After a sufficient amount of time for said melting and reaction to occur has elapsed, the excitation power may be reduced, and the resulting material may be annealed, thereby allowing crystal growth.

In some embodiments, doping of the silicon may occur. The silicon may be in-situ doped with p-type or n-type dopants. Layers of various types of in-situ doping may be used alternately to form p-n or n-p semiconductor junction with minor modifications of experimental apparatus.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of a process apparatus that may be used in the formation of silicon sheets, in accordance with an embodiment of the invention;

FIG. 2 illustrates thermodynamic dependence on temperature for reduction of SiO₂ to Si by carbon, in accordance with an embodiment of the invention;

FIG. 3 illustrates thermodynamic dependence on pressure for the reduction of SiO₂ to Si by carbon, in accordance with an embodiment of the invention;

FIG. 4 shows a processing sequence of polycrystalline silicon sheet production in accordance with an embodiment of the invention, in accordance with an embodiment of the invention; and

FIG. 5 shows a cross sectional view of a graphite boat with topographical features on its surface, including (a) alumina coated graphite holder with pyramid shape features on its surface, (b) silicon film formed on topographical features within the graphite boat, and (c) silicon film (inverted) with complementary topographical features, in accordance with an embodiment of the invention.

### DETAILED DESCRIPTION OF THE INVENTION

### Overview

The invention provides a direct synthesis of polycrystalline silicon sheets from elemental carbon (C) and SiOₓ, wherein ‘x’ is a number greater than zero. In a preferable embodiment, the invention provides a direct synthesis of polycrystalline silicon sheets from silica (SiO₂) and elemental carbon (C). The silica and elemental carbon may be mixed in stoichiometric amounts, and put under radiofrequency (RF) or microwave (MW) excitation. Under controlled heating, elemental carbon (or another susceptor material) may inductively couple with a RF or MW excitation source to form an excited carbon species that can reduce silica (reducing it) to produce elemental silicon. Thus, microwave heating or radiofrequency heating combined with radiofrequency or microwave excitation, may be used. See reactions below:

SiO₂+2C→Si+2CO equation (a)

SiO₂+C→Si+CO₂ equation (b)

Si+C→SiC equation (c)

SiO₂+3C→SiC+2CO equation (d)

SiO₂+C→SiO+CO equation (e)

SiO₂+2SiC→3Si+2CO equation (f)

Equations c-e are undesired reactions. The temperature and pressure of the reaction can be carefully controlled such that equations (a) and (b) dominate.

Either Radio frequency (RF) or Microwave (MW) excitation can be effective in coupling energy (e.g., heat energy) required to effect the desired chemical reactions in the mixture of SiO₂ and carbon. A suitable RF or MW source that is commercially available can be effectively used for this purpose.

Thus, any suitable excitation source, including but not limited to RF excitation or MW excitation, may be used to couple heat energy within the production of silicon sheets. Such an excitation source may be applied for a desired duration. Such duration may be sufficient to cause the desired reaction from the material including SiO₂ and C, thus forming a resulting material.

The invention may advantageously provide the rapid synthesis of polycrystalline silicon sheets for solar cell (e.g., photovoltaic solar cell) manufacturing. In some embodiments, a process from providing starting material to a process apparatus to removing a silicon sheet from the process apparatus may take on the order of 10, 20 or 30 minutes.

Furthermore, the invention may also allow the synthesis of thin silicon sheets in a cost effective manner. The process of manufacturing the silicon sheets provided herein need not require the costly step of cutting or slicing silicon wafers to a desired shape. Instead, the silicon sheets may be formed by conforming to the shape of the crucible (or trough) into which the starting material is provided. Alternatively, some cutting, polishing, or slicing steps may be used in some situations.

The terms “excite”, “excitation” and “exciting”, as used herein, can refer to applying (or coupling) energy to a material to form excited species (e.g., radicals, anions, cations) of the material. Energy can be applied via a variety of methods, such as, e.g., induction, ultraviolet radiation, microwaves and capacitive coupling. A power source, such as a radiofrequency (RF) or microwave (MW) power source, can be used to apply energy to the material. In certain embodiments, excitation can be achieved with the aid of a direct plasma generator or a remote plasma generator. In an embodiment, for RF excitation, an RF generator can be in electrical communication (or electrical contact) with RF coils disposed inside a reaction chamber or outside the reaction chamber. In various embodiments, in the absence of coupling energy, material excitation is quenched or terminated.

### Experimental Set-Up And Procedure

In an aspect of the invention, a silicon sheet production system comprises a trough (or crucible) mounted on a susceptor block. In an embodiment, the trough is configured to accept a material mixture comprising carbon, such as elemental carbon, and SiOₓ (wherein ‘x’ is a number greater than zero), such as silica (SiO₂). In embodiments, the trough is circular, triangular, square, or rectangular in shape. In embodiments, the system further comprises a chamber configured to accept the trough and an excitation source configured to excite the material mixture in the trough. In an embodiment, the excitation source is in the chamber. In an embodiment, the excitation source comprises one or more RF coils in the chamber or outside the chamber. In embodiment, the system further comprises a pressure control system configured to control the pressure within the chamber. In an embodiment, the pressure control system is configured to control the pressure in the chamber during formation of the silicon sheet. In an embodiment, the silicon sheet production system further comprises a purging system to aid in evacuating the chamber. In certain embodiments, the silicon sheet production system further comprises infrared (IR)/visible (VIS) shielding around the excitation source (e.g., RF coils) and/or around the trough and susceptor block.

In various embodiments, the pressure control system includes a throttle valve and one or more pumps in fluid communication with the chamber. In an embodiment, the pressure control system includes a vacuum system comprising one or more pumps configured to evacuate the chamber prior to forming a silicon sheet and after forming the silicon sheet. In an embodiment, the pressure control system is configured to remove one or more of carbon monoxide (CO), carbon dioxide (CO₂) and oxygen, or resulting or residual gaseous species from the chamber during formation of the silicon sheet.

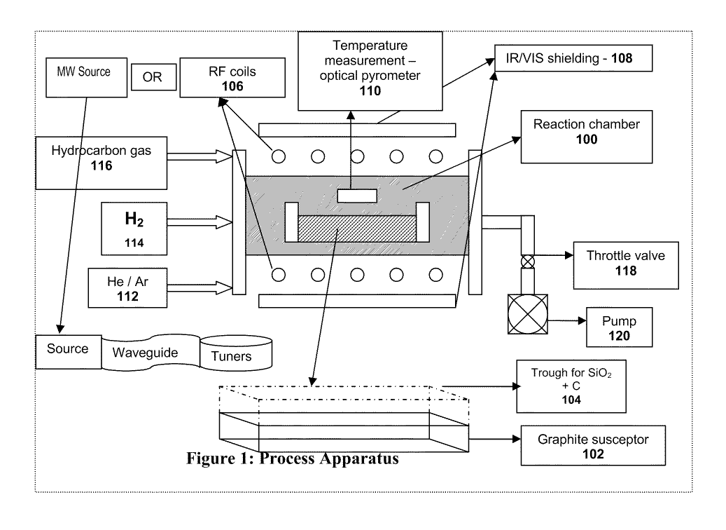

FIG. 1 shows an example of a process apparatus that may be used in the formation of silicon sheets. The apparatus may include a reaction chamber 100. The chamber may be enclosed. Alternatively, the chamber may be open or include open features. Preferably, the chamber may be sealable, or configured to reach an air-tight state. The chamber may have a housing, which may have one or more opening. The opening may be opened or closed as desired. In some embodiments, the reaction chamber may be a quartz, stainless steel, or sapphire enclosure.

The reaction chamber may be configured to accept a susceptor 102 and a trough 104 within the chamber. In some embodiments, the susceptor may be a graphite or silicon carbide susceptor block. The trough may be mounted on the susceptor. In some embodiments, the trough may be affixed to the susceptor. Alternatively, the trough may be removable from the susceptor. A trough may have any shape or configuration. In embodiments, the trough can have a circular, triangular, square, or rectangular shape. In other embodiments, the trough can have any geometric shape, such as, e.g., hexagonal or pentagonal. Other examples of shapes may include circles, squares, triangles, pentagons, hexagons, octagons, or any other regular or irregular shape. The trough may be shaped to produce a silicon sheet with a desired size and/or shape for a solar cell substrate. In some embodiments, the bottom of the trough may be smooth. Alternatively, the bottom of the trough may be textured to produce topographical features on the silicon sheet, which will be discussed in further detail below.

The trough may be formed from any material. In one example, the trough may be formed from graphite. The trough may also be coated or clad in a material. For instance, the trough may be coated with alumina (Al₂O₃). The susceptor block and/or trough may be made of graphite and coated with alumina in order to immunize it from any reactions. Other examples of materials that may be used include zirconia, boron nitride and sapphire.

A mixture of silica and carbon may be placed in a trough 104 (mounted on a susceptor block 102). The trough may already be within the reaction chamber 100 or may be provided to the reaction chamber after loading. In some embodiments, the trough may be manually provided to the reaction chamber, while in other embodiments, the trough may be automatically loaded within the reaction chamber.

The process apparatus may also include an excitation source 106. In one embodiment, the excitation source may be an RF coil. The RF coils may be wrapped around the reaction chamber 100 and shielded with infrared (IR)/visible (VIS) shields 108 to stop dissipation of heat, and control the heat within the chamber. Other examples of excitation sources may include other sources of RF excitation, or MW excitation. In some embodiments, the excitation source may be provided within the reaction chamber 100. Alternatively, the excitation source may be provided exterior to the reaction chamber but may provide excitation to the material with the silica and carbon within the reaction chamber.

When the material comprising silica and carbon is placed within the trough and coupled with RF or MW excitation, and then slowly annealed to grow crystals, a sheet of silicon may be produced (or other textured poly-crystalline silicon substrates). The sheet of silicon may conform to the shape of the trough. For example, if the material is placed within a rectangular trough, a rectangular sheet of silicon may be formed. The temperature of processing may be determined by the thermo-chemical analysis of the reactions as described in equations (a) through (c). The thickness and size of the produced polycrystalline silicon sheet may depend on the amount of starting material used.

An optical pyrometer 110 may be used in a closed loop temperature measurement scheme to monitor the temperature of the reactions. In other embodiments, other temperature measurement devices or sensors, such as thermocouples may be used to monitor the temperature within a reaction chamber 100. In some embodiments, the temperature sensor may be provided within the reaction chamber, while in other embodiments, the temperature sensor may be external to the reaction chamber but be able to monitor the temperature within the chamber or of the material within the chamber.

Prior to the start of the experiment or silicon manufacturing process, the chamber may be evacuated and de-moisturized with Helium (He)/Argon (Ar) 112, or hydrogen (H₂) 114, respectively. Any other evacuation and de-moisturizing techniques may be used. Such techniques may or may not include the inflow of various fluids (e.g., gaseous or liquid). The resulting gases from the reactions may be pumped out and evacuated to maintain pressure control. Pressure control and purging mechanism may include a throttle valve 118 and pump 120 attached to the process chamber. In some embodiments, pressure control can be achieved with the aid of a pumping system comprising one or more of a turbomolecular (“turbo”) pump, a cryopump, an ion pump and a diffusion pump, in addition to a backing pump, such as a mechanical pump. Other pressure control or purging mechanisms known in the art may be used. In some embodiments, the resulting gases may be removed after a period of time has elapsed. Alternatively, they may be pumped out as the incoming gas is entering the chamber.

During the reaction runs, additional suitable hydrocarbons 116 (such as CₓH_{y}-alkanes, alkenes, alkynes) may be introduced into the chamber to enhance and aid in reduction of silica. In situ doping (p or n type) of the produced silicon sheet can also be achieved through introduction of suitable dopants in the reaction chamber. In addition, in situ p-n junction formation can be achieved through the apparatus.

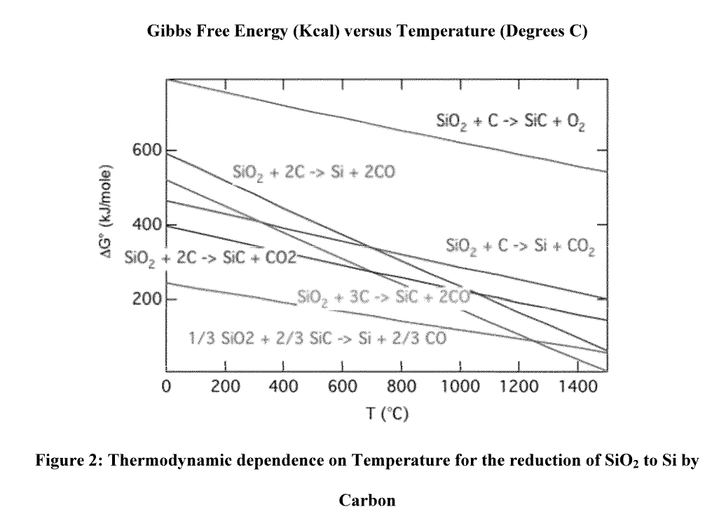

FIG. 2 illustrates thermodynamic dependence on temperature for reduction of SiO₂ to Si by carbon. As previously discussed, at least six sets of reactions (equations (a) through equation (f)) are possible during the carbothermic reduction of silica while producing elemental silicon (Si). Formation of SiC is thermodynamically favorable under certain process conditions (as indicated by equation (d)) due to its lower Gibbs Free Energy (ΔG) as indicated by the plot in FIG. 2, where Gibbs Free Energy (ΔG) is plotted with respect to temperature. Subsequently, SiC reacts with SiO₂ in the mixture to form elemental Si as shown in equation (f) and is thermodynamically favorable below 1250° C. under the conditions shown in FIG. 2.

As seen from the graphical representation, equation (f) is more sustainable, and provides a more favorable reaction, under certain process conditions, in the production of silicon. The reaction provided by equation (f) requires a lower ΔG than those provided by equations (a-e). The complex set of reactions—as depicted in FIG. 2 is only one aspect of the consideration of the invention. Controlling the temperature and pressure of the reactions can drive the reactions towards equation (a) for the end result.

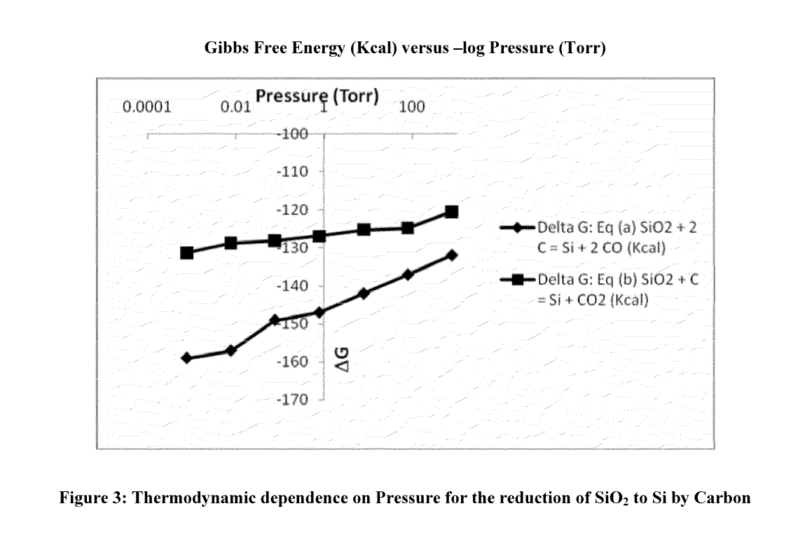

FIG. 3 illustrates thermodynamic dependence on pressure for the reduction of SiO₂ to Si by carbon. It is also imperative to point out that two solids (SiO₂ and C) are being used in the reaction as powder or in solution to produce a solid (Si) and a gaseous component (CO and CO₂). The gaseous by-products may be evacuated through the pump, and a low pressure reaction may be performed as a result. This may become increasingly favorable, in terms of thermodynamics of the reaction, as the pressure is progressively decreased. FIG. 3 illustrates where Gibbs Free Energy (ΔG) is plotted with respect to pressure.

The process may employ the temperature and pressure regimes that are favorable to the production of silicon, stoichiometrically as indicated by equation (a)—even though there may be other intermediate steps to the end result. FIG. 3 shows that the ΔG is higher for equation (b) over equation (a) for a given pressure.

### Processing Sequence

In an aspect of the invention, methods for forming a silicon-containing material, such as polycrystalline silicon, comprise providing a material mixture comprising carbon, such as elemental carbon, and SiOₓ (wherin ‘x’ is a number greater than zero), such as silica, to a system chamber. In an embodiment, the material mixture is provided in a trough in the system chamber. In another embodiment, the material mixture is placed in a susceptor trough, which is subsequently placed in the system chamber. Next, power (e.g., RF power, MW power) is provided to an excitation source to excite one or more of the silica and elemental carbon in the material mixture and any susceptor material. The excitation source can be disposed in the system chamber or outside of the system chamber. Next, a predetermined period of time is permitted (or allowed) to elapse. In an embodiment, the predetermined period of time is sufficient to form a resulting material from the material mixture, the resulting material comprising silicon. In an embodiment, one or more of carbon monoxide and carbon dioxide are removed from the system chamber while forming the resulting material from the material mixture. Next, power to the excitation source is reduced. In an embodiment, power to the excitation source is terminated. Next, the resulting material is annealed to allow or facilitate crystal growth. In an embodiment, the resulting material is cooled in an inert gas atmosphere. In an embodiment, the inert gas includes one or more of He, Ne, or Ar. In an embodiment the resulting material may be cooled in N₂. In a preferable embodiment, the inert gas comprises one or more of He and Ar, such as, e.g., a He and Ar mixture. In embodiments, the flow rate and pressure of inert gas is selected so as to achieve a desired cooling rate. In embodiments, a seed crystal may be introduced to initiate crystal formation.

In some embodiments, the susceptor trough is heated during formation of the resulting material. The susceptor trough can be heated with the aid of a resistive heating unit in thermal contact with the susceptor trough, or by inductive or capacitive coupling to a heating source.

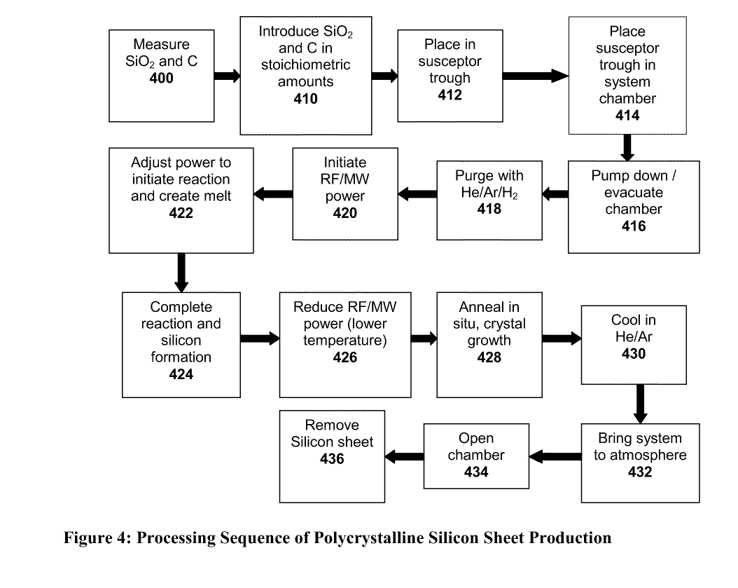

FIG. 4 shows a processing sequence of polycrystalline silicon sheet production in accordance with an embodiment of the invention. A method may be provided for manufacturing a silicon sheet. In step 400, the amount of silica (SiO₂) and elemental carbon (C) may be measured. A starting material may be provided containing a mixture of silica and carbon. Next, in step 410, the silica and carbon may be introduced in stoichiometric amounts to form a mixture. In some embodiments, the silica and carbon may be separately measured and combined into the mixture to provide desired (or predetermined) amounts. Next, in step 412, the starting material with the mixture may be placed within a susceptor trough.

Next, in step 414, the susceptor trough, which may contain the starting material or material mixture comprising silica and carbon, can be placed within a system chamber. In various embodiments, the system chamber is a vacuum chamber. The trough may be manually placed within the system chamber. Alternatively, automated components, such as, e.g., a robot and/or a conveyor belt, may cause the chamber to accept the trough and put it into a desired position in the system chamber. Alternatively, the starting material may be placed within the susceptor trough that may already be within the system chamber.

In some embodiments, once the material has been introduced into the system chamber, the chamber may be closed or sealed. In step 416, the chamber may be pumped down or evacuated. This may cause the pressure within the chamber to drop. In step 418, the chamber may also be purged with fluids, such as gases (e.g., helium, argon, hydrogen, or any combination thereof) or liquids. In some embodiments, the purging fluids may be introduced to the chamber after the chamber has been pumped down or evacuated. In other embodiments, the fluids may be introduced while the chamber is being pumped.

Next, in step 420, excitation power may be applied to excite the material within the chamber. For example, the starting material may be excited with RF excitation or MW excitation. If the excitation source is an RF coil, the RF coil may be initiated (i.e., power can be applied to the RF coil). In step 422, power may also be adjusted to initiate a reaction within the chamber and to create a melt from the starting material. The resulting material may comprise silicon and may be melted. Optionally, in some embodiments, during the reaction runs, additional suitable hydrocarbons (such as, e.g., CₓH_{y}-alkanes, alkenes, alkynes) may be introduced into the chamber to enhance and aid in reduction of silica, or to aid in the elimination of impurities.

The excitation power may be continued for a predetermined (or desired) period of time sufficient to provide the desired silicon formation from the starting material, to form the resulting material. In some embodiments, the predetermined period of time sufficient to provide for silicon formation from the mixture is less than or equal to 30 seconds, or less than or equal to 1 minute, or less than or equal to 2 minutes, or less than or equal to 5 minutes, or less than or equal to 10 minutes, or less than or equal to 30 minutes, or less than or equal to 1 hour, or less than or equal to 2 hours. In some embodiments, the excitation power may be provided for a predetermined length of time. In some instances, the predetermined time may be entered by a user, may be automatically calculated, or may be adjusted based on sensor measurements. In step 424, the amount of time may be sufficient to complete the reaction and provide silicon formation. Next, in step 426, after the amount of time, the excitation power may be reduced and/or the temperature may be lowered.

In step 428, the resulting material may be annealed in situ, and crystal growth may occur. In some embodiments, the annealing process may be controlled to provide desired material properties of the resulting material. As the resulting material cools and crystallizes, it may conform to the shape provided by the susceptor trough. Thus, a silicon sheet conforming to the trough may be formed. In some embodiments, in step 430, the silicon material may be cooled in He and/or Ar atmosphere. The He/Ar may be provided using the same source through which He/Ar may have been provided during an earlier purging stage (e.g., step 418). Alternatively, it may be provided by another source. In some embodiments, a different fluid, such as a gas, or combination of fluids may be provided to cool the silicon material.

Optionally, in some embodiments, before, during, and/or after the excitation power is provided, one or more dopants may be provided to the reaction chamber. The in situ doping (p or n type) within the reaction chamber may be achieved through introduction of suitable dopants in the reaction chamber. In addition, in situ p-n junction formation can be achieved through the apparatus. Such options may be discussed in greater detail below.

Next, in step 432, the entire system may be brought to atmospheric pressure. In an embodiment, the pressure may be brought to atmospheric pressure and/or the temperature may be brought to the ambient temperature. Similarly, the gases within the chamber may be brought to ambient gases. This process may be gradual, or may occur rapidly. Next, in step 434, the chamber may be opened and/or unsealed.

Next, in step 436, after the chamber has been opened the silicon sheet may be removed. In some embodiments, the silicon sheet may be removed directly from the trough within the chamber. Alternatively, the trough may be removed from the chamber, and then the silicon sheet may be removed from the trough. In some embodiments, the trough may be ejected from the chamber without opening a separate compartment of the chamber.

Any of the steps discussed herein may be optional and/or additional or substitute steps may be provided. Furthermore, the steps need not occur in the order presented, and variance in the order may be provided.

### Additional Processing Techniques

### 1. Textured Polycrystalline Silicon Substrates Can Be Produced In the Technique We Have Explained Earlier

In an aspect of the invention, methods for forming texture polycrystalline silicon substrates comprise providing a substrate holder having a trough with features therein. In an embodiment, the features are corrugated features on an exposed surface of the trough.

Next, a silicon film is formed in the textured substrate holder by exciting a material mixture comprising silica with the aid of an excitation source (e.g., RF source, MW source) and reducing power to the excitation source after a predetermined period of time has elapsed. In an embodiment, upon providing power to the excitation source, CO and/or CO₂ evolve from the trough upon polycrystalline formation, and the predetermined period of time is the point in time beyond which CO and/or CO₂ evolution cannot be detected or the rate of evolution changes. In embodiments, the predetermined period of time is less than or equal to 30 seconds, or less than or equal to 1 minute, or less than or equal to 2 minutes, or less than or equal to 5 minutes, or less than or equal to 10 minutes, or less than or equal to 30 minutes, or less than or equal to 1 hour, or less than or equal to 2 hours. In an embodiment, the material mixture further comprises carbon, such as elemental carbon. In an embodiment, the silicon film thus formed has topographical features that conform to the topography of the features in the trough.

Next, the silicon film is removed from the textured substrate holder. In an embodiment, the silicon film has topographical features that conform to the underlying topography of the features in the trough of the textured substrate holder. In another embodiment, the silicon film has topographical features that substantially conform to the underlying topography of the features in the trough of the textured substrate holder.

In embodiments, the textured substrate holder is formed of graphite, boron nitride, sapphire, or zirconia. In certain embodiments, the textured substrate holder is coated with alumina, boron nitride or zirconia. For example, the textured substrate holder can be formed of graphite and a layer of alumina overlying the graphite. In another embodiment the substrate holder is formed of Zirconium Oxide (ZrO₂).

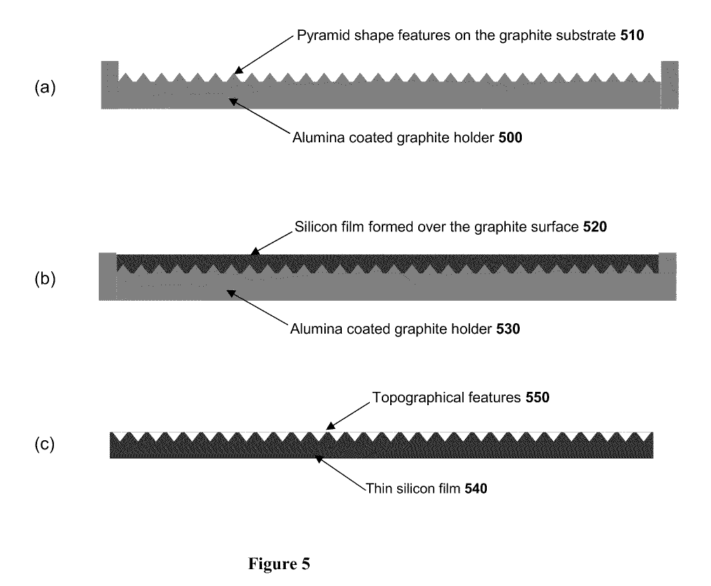

FIG. 5 shows a cross sectional view of a graphite boat with topographical features on its surface, including (a) alumina coated graphite holder 500 with pyramid shape features on its surface 510, (b) silicon film formed on topographical features 520 within the graphite boat 530, and (c) silicon film (inverted) 540 with complementary topographical features 550.

Silicon film can be textured in situ by employing a textured substrate holder within which it is synthesized. Various topographies such as pyramidal, triangular, circular, bumps, grooves, etc., structures may be formed on the film surface by creating a complementary topography on the surface of a substrate holder. A cross-sectional magnified view of pyramidal features is shown in FIG. 5. Such features are machined on to the surface of the graphite boat or trough with high precision. The features may be etched, scribed, cast, molded, attached to the surface, or formed in any other manner. As previously described, the trough may have any overall shape. In some embodiments, the bottom of the trough may be relatively flat, while in other embodiments, it may be curved or have other configurations. The trough bottom may be complementary to the desired silicon sheet shape or arrangement.

During silicon synthesis, as silicon film is formed within the graphite holder, it conforms to the underlying topography of the surface. Such topographical features are of high value to help generate multiple reflections of the sun rays in order to capture maximum photon energy and thus help increase photo-conversion efficiency.

After the silicon film has sufficiently annealed or hardened, the silicon may be removed from the graphite holder. The silicon film may be a thin polycrystalline silicon film. Once the film has been removed, the topographical features of the film may be exposed.

### 2. Additional Hydrocarbons For Reduction of Silica

In some embodiments, during a reaction run, hydrocarbons such as CₓH_{y}, e.g., alkanes (CₙH₂ₙ₊₂), alkenes (CₙH₂ₙ), alkynes (CₙH₂ₙ₋₂), may be introduced into the chamber to enhance and aid in the reduction of silica, or removal of impurities. In other embodiments, any other fluid, may be introduced into the chamber before, during, and/or after the excitation energy is applied to the material to aid in the reaction.

### 3. In Situ Doping of Produced Polycrystalline Silicon Sheets

Thin film of silicon being formed within the alumina coated graphite holder can be effectively doped by a suitable chemical dopant in situ to obtain a desired type and degree of electrical conductivity. For example, p-type doping of silicon can be obtained by flowing a predetermined amount of a p-type dopant, such as diborane (B₂H₆) gas or boron trichloride (BCl₃), over the silicon substrate being formed. Similarly, appropriate level of n-type conductivity can be generated by flowing a predetermined amount of a suitable n-type dopant, such as a phosphorous-containing compound (e.g., PCl₃ , PCl₅ , POCl₃), over the silicon surface in the graphite boat.

Such dopants may be flowed over or through the silicon substrate before, during, and/or after an excitation power is applied to the silicon substrate. For example, dopants may be provided while an RF excitation or an MW excitation is applied to the silicon substrate. The dopants may be flowed over the substrate for a desired period of time. Such a period of time may be less than, be the same as, or exceed the amount of time that an excitation energy is applied to the material. In some embodiments, the flow rate of the dopants being passed through the reaction chamber may be controlled. Similarly, the amount of dopant provided to the reaction chamber may be controlled.

### 4. In Situ P-N Junction Formation

An effective p-n junction can be formed in situ within the thin film silicon layer in the graphite boat through various methods.

In a first method, a p-type silicon layer may first be formed by flowing a boron containing gas over the thin silicon film during its formation process. Subsequently, a conversion of silica to silicon may be completed. The completion of the conversion may be confirmed through cessation of detection of CO and/or CO₂ gas in an effluent stream. One or more sensors may be provided to detect the presence or absence and/or concentration of CO and/or CO₂ gas. After the conversion, an appropriate phosphorous containing compound may be passed over the silicon surface for a pre-determined time in a pre-determined quantity. This may result in the n-type silicon layer.

Similar techniques can be used to form an n-type Si substrate first followed by a p-layer to form the p-n junction. For example, a n-type silicon layer may be formed first by flowing a phosphorous containing gas over a thin silicon film during its formation process. Then, either after the conversion of silica to silicon, or during MW/RF excitation, a gas containing boron may be flowed through the chamber to form a p-type silicon layer over the n-type layer. Any other n-type dopants and p-type dopants known in the art may be used.

In various embodiments, a control system is provided for controlling (or automating) the formation of silicon sheets or films. The control system can include one or more computer systems. In an embodiment, the control system is configured to control throttle valves and/or pumping systems in fluid communication with a reaction chamber (or vacuum chamber) in which a silicon film is formed, thereby controlling the pressure in the reaction chamber. In an embodiment, the control system is configured to control the power to an excitation source, thereby controlling silicon film formation. In an embodiment, the control system is configured to detect the evolution of CO and/or CO₂ from a trough in the reaction chamber, and to determine when silicon film formation has terminated. In still another embodiment, the control system is configured to control the feed, flow rate, and partial pressures of one or more vapors, such as inert gases, hydrocarbons, and n ad p-type dopants, into the reaction chamber. In still another embodiment, the control system is configured to control the placement of a substrate holder having a trough into the reaction chamber.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for forming a silicon-containing material, comprising:
providing power to an excitation source to excite one or more of silica and elemental carbon in a material mixture;
waiting a predetermined period of time to form a resulting material from the material mixture, the resulting material comprising silicon;
reducing power to the excitation source; and
annealing the resulting material, thereby allowing crystal growth.

2. The method of claim 1, further comprising removing one or more of carbon monoxide and carbon dioxide from a system chamber having the material mixture while forming the resulting material form the material mixture.

3. The method of claim 1, wherein said excitation source comprises at least one of a radiofrequency (RF) excitation source and a microwave (MW) excitation source.

4. The method of claim 1, further comprising placing the material mixture in a susceptor trough and placing the susceptor trough in a system chamber prior to providing power to the excitation source.

5. The method of claim 1, further comprising cooling the resulting material in an inert gas atmosphere.

6. The method of claim 5, wherein the inert gas comprises one or more of He and Ar.

7. A silicon sheet production system, comprising:
a trough mounted on a susceptor block, said trough configured to accept a material mixture comprising elemental carbon and SiOₓ, wherein ‘x’ is a number greater than zero;
a chamber configured to accept the trough;
an excitation source configured to excite the material mixture within the trough; and
a pressure control system configured to control the pressure within the chamber.

8. The system of claim 7, further comprising a purging system to aid in evacuating the chamber.

9. The system of claim 7, wherein SiOₓ includes silica (SiO₂).

10. The system of claim 7, wherein the excitation source is in the chamber.

11. The system of claim 7, wherein the trough is circular, triangular, square, or rectangular in shape.

12. The system of claim 7, wherein the excitation source comprises an RF coil.

13. The system of claim 7, further comprising infrared (IR)/visible (VIS) shielding around the excitation source.

14. The system of claim 7, wherein the pressure control system includes a throttle valve and one or more pumps in fluid communication with the chamber.

15. A method for forming textured polycrystalline silicon substrates, comprising:
providing a textured substrate holder having a trough with features on a surface of the trough;
forming a silicon film within the textured substrate holder by exciting a material mixture comprising silica with the aid of an excitation source and reducing power to the excitation source after a predetermined period of time has elapsed; and
removing the silicon film from the textured substrate holder, wherein said silicon film has topographical features conforming to the underlying topography of the features in the trough of the textured substrate holder.

16. The method of claim 15, wherein the material mixture further comprises elemental carbon.

17. The method of claim 15, wherein the textured substrate holder is formed of graphite, boron nitride, sapphire, or zirconia.

18. The method of claim 15, wherein the textured substrate holder is coated with alumina, boron nitride or zirconia.

19. The method of claim 15, wherein said exciting step is performed using at least one of the following: radiofrequency (RF) excitation and microwave (MW) excitation.
